(19) United States
(12) Patent Application Publication
(10) Pub. No.: US 2025/0334401 A1
(43) Pub. Date: Oct. 30, 2025

(54) DEFECT DETECTION SYSTEM AND DEFECT DETECTION METHOD OF NON-COATED PORTION OF ELECTRODE ASSEMBLY

(71) Applicant: SK On Co., Ltd., Seoul (KR)

(72) Inventors: Hyeong Yun LEE, Daejeon (KR); Young Jin KIM, Daejeon (KR); Joo Hun KIM, Daejeon (KR); Sang Ik LEE, Daejeon (KR)

(21) Appl. No.: 19/193,967

(22) Filed: Apr. 30, 2025

(30) Foreign Application Priority Data
Apr. 30, 2024 (KR) 10-2024-0057734
Apr. 1, 2025 (KR) 10-2025-0042193

(51) Int. Cl. G01B 21/30; G01B 21/04; G01B 21/20; H01M 4/02

(52) U.S. Cl. CPC G01B 21/30; G01B 21/04; G01B 21/20; H01M 4/02; H01M 2004/021

(57) ABSTRACT

The present disclosure relates to a defect detection system and a defect detection method of non-coated portion of an electrode assembly. The defect detection system of the non-coated portion of the electrode assembly includes a support device supporting the electrode assembly, a gripping device gripping and bending one side of the non-coated portion of the electrode assembly, a measuring device measuring a surface shape of the non-coated portion, and a detection device representing information on the surface shape by coordinates in a coordinate system and detecting a defect in the non-coated portion based on the coordinates.

### CROSS-REFERENCE TO RELATED PATENT APPLICATION

The present disclosure claims priority under 35 U.S.C. § 119(a) to Korean patent application number 10-2024-0057734, filed on Apr. 30, 2024 and Korean patent application number 10-2025-0042193, filed on Apr. 1, 2025, in the Korean Intellectual Property Office, the entire disclosure of which is incorporated herein by reference.

### BACKGROUND OF THE INVENTION

### 1. Field

Various embodiments of the present disclosure generally relate to a defect detection system and a defect detection method of non-coated portion of an electrode assembly.

### 2. Description of the Related Art

A secondary battery includes an electrode assembly including a cathode, an anode, and a separator interposed between the cathode and the anode.

The cathode or the anode of the electrode assembly is formed by forming a cathode active material layer or an anode active material layer on a thin film substrate. In the electrode assembly, a cathode tab or an anode tab may be coupled to a non-coated portion of the cathode or the anode to which the cathode active material layer or the anode active material layer is not formed.

For example, the cathode includes a coated portion coated with the cathode active material on the substrate in the form of a thin film or foil, and a non-coated portion not coated with the cathode active material. The anode electrode includes a coated portion coated with an anode active material on a substrate in the form of a thin film or foil, and a non-coated portion not coated with the anode active material. In each of the cathode and anode electrodes, the non-coated portion may include a region where the cathode active material or anode active material is not coated, thereby exposing the substrate in the form of a thin film or foil.

In general, the cathode tab or the anode tab is coupled to the non-coated portion by welding, and in this case, wrinkling or cracking may occur in the non-coated portion depending on the welding environment. In a case where the non-coated portion is defective due to wrinkling or cracking of the non-coated portion, the performance of the secondary battery may be degraded, the secondary battery might not be operated, or other problems may occur. Therefore, it is necessary to detect whether the non-coated portion is defective to prevent or mitigate the defect in the secondary battery.

In a conventional method, a defect in non-coated portion was detected by photographing the non-coated portion with a camera or the like and visually inspecting the photographed image of a screen, but it is not easy to accurately detect a defect in the non-coated portion in which shading occurs or various weld shapes are formed only by inspecting the image of the screen.

### SUMMARY OF THE INVENTION

One aspect of embodiments of the present disclosure provides a system capable of detecting a defect in non-coated portion of an electrode assembly more quickly and accurately.

Another aspect of embodiments of the present disclosure provides a method capable of detecting a defect in non-coated portion of an electrode assembly more quickly and accurately.

As a technical means to solve the above-described technical problems, a defect detection system of a non-coated portion of an electrode assembly according to an embodiment of the present disclosure may include a support device configured to support the electrode assembly, a gripping device configured to grip and bend one side of the non-coated portion of the electrode assembly, a measuring device configured to measure a surface shape of the non-coated portion to obtain measurement information, and a detection device configured to represent the measurement information using coordinates within a coordinate system and detect a defect in the non-coated portion based on the coordinates.

In addition, the non-coated portion may include an inclined surface which is formed by bending the non-coated portion by moving of the gripping device in a first direction, and a flat surface which is bent from the inclined surface by being gripped by the gripping device and extends in a second direction perpendicular to the first direction, and wherein the coordinate system includes a first coordinate axis parallel to the second direction, a second coordinate axis parallel to a third direction perpendicular to the first direction and the second direction, and a third coordinate axis parallel to the first direction.

In addition, the detection device may calculate a slope of the inclined surface in the second direction using the coordinates; and determine that the inclined surface is defective when the slope is less than or equal to a preset first value or greater than or equal to a preset second value.

In addition, the flat surface may include a welded portion welded to an electrode tab and a flat portion which is a portion of the flat surface except for the welded portion, and wherein the detection device: calculates a difference in coordinate value of the third coordinate axis between portions adjacent to each other in the direction of the first coordinate axis among portions having a same coordinate value of the first coordinate axis of the flat portion; and determines that the flat portion is defective when the difference in coordinate value of the third coordinate axis between the portions adjacent to each other in the direction of the first coordinate axis among the portions having the same coordinate value of the first coordinate axis of the flat portion is greater than or equal to a preset third value.

In addition, the detection device may calculate a difference in coordinate value of the third coordinate axis between portions adjacent to each other in the direction of the first coordinate axis among portions having a same coordinate value of the first coordinate axis of the welded portion; and may determine that the welded portion is defective when the difference in coordinate value of the third coordinate axis between the portions adjacent to each other in the direction of the first coordinate axis among the portions having the same coordinate value of the first coordinate axis of the welded portion is greater than or equal to a preset fourth value.

In addition, a welded mass may be formed in at least a part of the welded portion, and wherein the detection device may calculate a difference in coordinate value of the third coordinate axis between a portion in which the welded mass is formed and a portion adjacent thereto in the direction of the first coordinate axis among the portions having the same coordinate value of the first coordinate axis of the welded portion and may determine that the welded portion is defective when the difference in coordinate value of the third coordinate axis between the portion in which the welded mass is formed and the portion adjacent thereto in the direction of the first coordinate axis among the portions having the same coordinate value of the first coordinate axis of the welded portion is greater than or equal to a preset fifth value.

In addition, the preset fourth value may be greater than the preset third value, and wherein the preset fifth value is greater than the preset fourth value.

In addition, the gripping device may comprise a lower cylinder configured to press an end portion of the bottom surface of the non-coated portion in the first direction; and an upper cylinder configured to press the end portion of the top surface of the non-coated portion in a direction opposite to the first direction.

In addition, the measuring device may include a profile sensor.

As a technical means to solve the above-described technical problems, a defect detection method of non-coated portion of an electrode assembly according to an embodiment of the present disclosure may comprise a supporting step of supporting the electrode assembly, a bending step of gripping and bending one side of the non-coated portion of the electrode assembly, a measuring step of measuring a surface shape of the non-coated portion to obtain measurement information; and a detecting step of representing the measurement information using coordinates within a coordinate system; and detecting a defect in the non-coated portion based on the coordinates.

In addition, the non-coated portion may include an inclined surface which is formed by bending the non-coated portion by moving of a gripping device in a first direction, and a flat surface which is bent from the inclined surface by being gripped by the gripping device and extends in a second direction perpendicular to the first direction, and wherein the coordinate system may include a first coordinate axis parallel to the second direction, a second coordinate axis parallel to a third direction perpendicular to the first direction and the second direction, and a third coordinate axis parallel to the first direction.

In addition, the detecting step may include a first determining step of calculating a slope of the inclined surface in the second direction using the coordinates, and determining that the inclined surface is defective when the slope is less than or equal to a preset first value or greater than or equal to a preset second value.

In addition, the flat surface may include a welded portion welded to an electrode tab and a flat portion which is a portion of the flat surface except for the welded portion, and wherein the detecting step further includes a second determining step of calculating a difference in coordinate values of the third coordinate axis between portions adjacent to each other in the direction of the first coordinate axis among portions having a same coordinate value of the first coordinate axis of the flat portion, and determining that the flat portion is defective when the difference in the coordinate values of the third coordinate axis between the portions adjacent to each other in the direction of the first coordinate axis among the portions having the same coordinate value of the first coordinate axis of the flat portion is greater than or equal to a preset third value.

In addition, the detecting step further may include a third determining step of calculating a difference in coordinate values of the third coordinate axis between portions adjacent to each other in the direction of the first coordinate axis among portions having a same coordinate value of the first coordinate axis of the welded portion, and determining that the welded portion is defective when the difference in the coordinate values of the third coordinate axis between the portions adjacent to each other in the direction of the first coordinate axis among the portions having the same coordinate value of the first coordinate axis of the welded portion is greater than or equal to a preset fourth value.

In addition, a welded mass may be formed in at least a part of the welded portion, and wherein the detecting step includes a fourth determining step of calculating a difference in coordinate values of the third coordinate axis between a portion in which the welded mass is formed and a portion adjacent thereto in the direction of the first coordinate axis among the portions having the same coordinate value of the first coordinate axis of the welded portion, and determining that the welded portion is defective when the difference in the coordinate values of the third coordinate axis between the portion in which the welded mass is formed and the portion adjacent thereto in the direction of the first coordinate axis among the portions having the same coordinate value of the first coordinate axis of the welded portion is greater than or equal to a preset fifth value.

Details of other embodiments for solving the technical problems are included in the description of the present disclosure and drawings.

According to the above-described technical means of the present disclosure, a defect detection system and a defect detection method of non-coated portion of an electrode assembly according to the present disclosure may accurately detect a defect in the non-coated portion because a detection device coordinates the shape of the non-coated portion and detects the defect in the non-coated portion based the coordinates.

In addition, because the defect in the non-coated portion is detected with different defect detection conditions for respective portions of the non-coated portion, the defect in the non-coated portion may be detected more accurately.

In addition, because the defect in the non-coated portion is automatically detected using the detection device, the defect in the non-coated portion may be detected more quickly.

### BRIEF DESCRIPTION OF THE DRAWINGS

FIG. 1 is a diagram illustrating a defect detection system of non-coated portion of an electrode assembly according to an embodiment of the present disclosure.

FIG. 2 is a diagram of a side surface of a defect detection system of non-coated portion of an electrode assembly.

FIG. 3 is a diagram illustrating non-coated portion in which an inclined surface and a flat surface are formed.

FIG. 4 is a flowchart illustrating a defect detection method of non-coated portion of an electrode assembly according to an embodiment of the present disclosure.

FIG. 5 is a flowchart illustrating a detecting step.

### DETAILED DESCRIPTION

Hereinafter, embodiments of the present disclosure will be described in detail with reference to the accompanying drawings so that those skilled in the art can easily implement the embodiments. However, the present disclosure may be implemented in various different forms and is not limited to the embodiments described herein. In addition, in order to clearly explain the present disclosure in the drawings, parts irrelevant to the description have been omitted, and similar reference numerals have been given to similar elements throughout the specification.

Throughout this specification, when a part is “connected” to another part, this includes not only “directly connected” but also “electrically connected” with another element interposed therebetween.

Throughout this specification, when a member is “on” another member, this includes not only when the member is in contact with the other member, but also when there is another member between the two members.

Throughout this specification, when a part “includes” a certain component, it means that other components may be further included, rather than excluding other components, unless otherwise specified. The terms “about,” “substantially,” and the like, used throughout this specification, are used in or near their numerical values when manufacturing and material tolerances inherent in the stated meaning are presented, and exact or absolute numerical values are used to aid in the understanding of this disclosure in order to prevent unconscionable exploitation of the stated disclosure by unscrupulous infringers. As used throughout this specification, the term “step” or “step of” does not mean “step for”.

Hereinafter, embodiments of the present disclosure will be described in detail with reference to the accompanying drawings and the contents described below. However, the present disclosure is not limited to the embodiments described herein and may be embodied in other forms. Like reference numerals refer to like elements throughout the specification.

Hereinafter, a defect detection system of non-coated portion of an electrode assembly according to an embodiment of the present disclosure will be described.

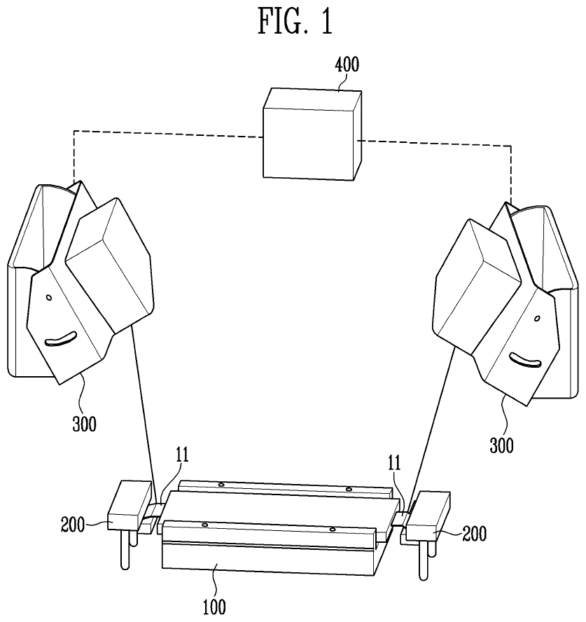

FIG. 1 is a diagram illustrating a defect detection system of non-coated portion of an electrode assembly 10 according to an embodiment of the present disclosure.

Referring to FIG. 1, the defect detection system of the non-coated portion of the electrode assembly includes a support device 100, a gripping device 200, a measuring device 300, and a detection device 400.

First, the support device 100 will be described.

The support device 100 may support the electrode assembly 10.

For example, the support device 100 may be configured in a jig so that the electrode assembly 10 may be seated on the support device 100, and may be configured to be capable of fixing the electrode assembly 10 so that the electrode assembly 10 seated thereon are not moved.

The electrode assembly 10 seated on the support device 100 may include a cathode, an anode, and a separator interposed between the cathode and the anode, and the cathode and the anode each have extended non-coated portion.

The cathode may be formed by applying a cathode active material such as a transition metal oxide to a cathode current collector including metal foil such as aluminum.

In addition, the cathode includes cathode non-coated portion, which is an area to which the cathode active material is not applied, and the cathode non-coated portion may serve as a passage for current flow between the cathode and the outside.

The anode may be formed by applying an anode active material such as graphite or carbon to an anode current collector including metal foil such as copper or nickel.

In addition, the anode includes anode non-coated portion, which is an area to which the anode active material is not applied, and the anode non-coated portion may serve as a passage for current flow between the anode and the outside.

The separator is located between the cathode and the anode, preventing or mitigating short circuits and enabling the movement of lithium ions. The above-described separator may include polyethylene, polypropylene, or a composite film of polyethylene and polypropylene.

The above-described electrode assembly 10 may be supported by the support device 100 such that non-coated portion 11 of the cathode or the anode protrudes toward at least one side.

Next, the gripping device 200 will be described.

Referring to FIG. 1, the gripping device 200 may grip and bend one side of the non-coated portion 11 of the electrode assembly 10, and may be configured to be movable while gripping the non-coated portion 11.

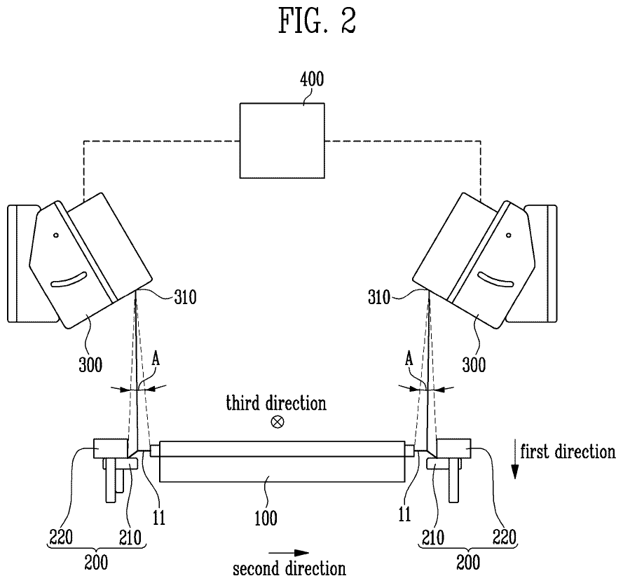

FIG. 2 is a diagram of a side surface of a defect detection system of the non-coated portion 11 of the electrode assembly 10.

For example, as shown in FIG. 2, the gripping device 200 may include a lower cylinder 210 and an upper cylinder 220.

The lower cylinder 210 may be configured to press an end portion of one side of the non-coated portion 11 in a first direction, and the upper cylinder 220 may be configured to press the end portion of the one side of the non-coated portion 11 in a direction opposite to the first direction.

That is, the gripping device 200 may bend the electrode assembly 10 by moving in the first direction while gripping the one side of the non-coated portion 11 with the lower cylinder 210 and the upper cylinder 220, and the first direction may be parallel to the direction of gravity while being perpendicular to a direction in which the non-coated portion 11 protrudes from the electrode assembly 10.

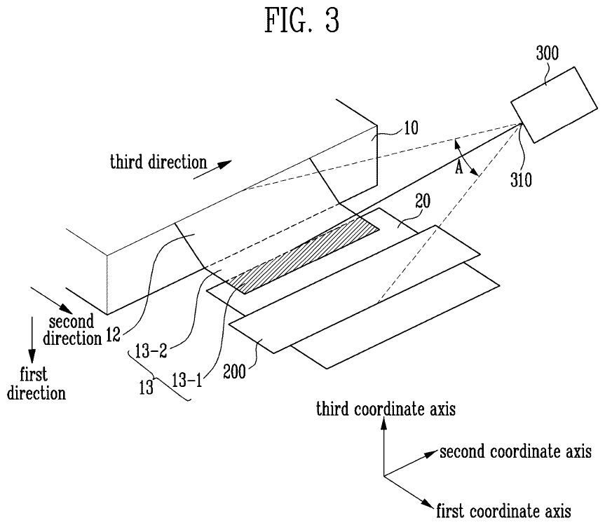

FIG. 3 is a diagram illustrating the non-coated portion 11 in which an inclined surface 12 and a flat surface 13 are formed.

Then, referring to FIG. 3, the non-coated portion 11 includes the inclined surface 12 bent by the movement of the gripping device 200 in the first direction, and the flat surface 13 bent from the inclined surface 12 by being gripped by the gripping device 200 and extending in a second direction perpendicular to the first direction.

When the inclined surface 12 is formed on the non-coated portion 11 by the movement of the gripping device 200 as described above, wrinkling or cracking formed in the non-coated portion 11 may be more effectively observed, so that the defect in the non-coated portion 11 may be more easily detected.

Next, the measuring device 300 will be described.

The measuring device 300 may measure the surface shape of the non-coated portion 11 within a range of a predetermined measurement area A, and may include a profile sensor (310).

For example, the measuring device 300 may include a tiltable and movable bracket and a profile sensor (310) coupled to the bracket. The profile sensor (310) coupled to the bracket may scan the surface shape of the non-coated portion 11 while moving in a tilted state at a predetermined angle.

The measuring device 300 may measure the shape of a portion of the non-coated portion 11 except for a portion of the non-coated portion 11 in which a defect is not easily detected through the measurement of the surface shape due to the characteristics of a preceding process.

For example, the portion of the non-coated portion 11, which starts to extend from the cathode or the anode and is located between the cathode or the anode and the inclined surface 12, has the irregular surface shape due to the characteristics of the preceding process, and therefore the measuring device 300 may be configured to measure the shape of the remaining portion of the non-coated portion 11 except for this portion within the range of the predetermined measurement area A.

In addition, the measuring device 300 according to an embodiment may include a plurality of measuring devices 300 to simultaneously measure cathode and anode portions of the non-coated portion 11 of the electrode assembly 10, and for example, the plurality of measuring devices 300 may be respectively arranged at positions corresponding to the non-coated portion 11 of the cathode and the anode.

Next, the detection device 400 will be described.

The detection device 400 may include a computer and may be configured to receive information on the surface shape of the non-coated portion 11 measured by the measuring device 300, either wired or wirelessly.

Then, the detection device 400 may represent the information on the surface shape of the non-coated portion 11 by coordinates in a coordinate system, and detect a defect in the non-coated portion 11 based on the coordinates.

As shown in FIG. 3, the coordinate system may include a first coordinate axis parallel to the second direction, a second coordinate axis parallel to a third direction perpendicular to the first direction and the second direction, and a third coordinate axis parallel to the first direction.

The detection device 400 may detect a defect in the inclined surface 12.

Specifically, the detection device 400 may calculate the slope of the inclined surface 12 in the second direction by using the coordinates for the surface shape of the non-coated portion 11 represented in the coordinate system, and determine that the inclined surface 12 is defective when the slope is less than or equal to a preset first value or greater than or equal to a preset second value.

The slope of the inclined surface 12 in the second direction may be obtained by dividing the difference in coordinate value of the third coordinate axis by the difference in coordinate value of the first coordinate axis, of coordinates having the same coordinate value of the second coordinate axis.

For example, the slope of the inclined surface 12 in the second direction of coordinates having a coordinate value of (1, 2, 3) and coordinates having a coordinate value of (2, 2, 5) is 2 obtained by dividing 2 by 1.

The slope of the inclined surface 12 may be greater than the preset first value and less than the preset second value when there is no wrinkling or cracking of the inclined surface 12.

However, when the inclined surface 12 is wrinkled or cracked, a concavely recessed portion or a convexly protruding portion is formed on the inclined surface 12, so that the slope between coordinates of the inclined surface 12 having the same coordinate value of the second coordinate axis may be less than or equal to the preset first value or greater than or equal to the preset second value.

Therefore, when the slope is less than or equal to the preset first value or greater than or equal to the preset second value, the detection device 400 may determine that the inclined surface 12 is defective, thereby detecting the defect in the non-coated portion 11.

As shown in FIG. 3, the flat surface 13 of the non-coated portion 11 may include a welded portion 13-1 welded to an electrode tab 20 and a flat portion 13-2 which is a portion of the flat surface 13 except for the welded portion 13-1.

In addition, the detection device 400 may detect a defect in the flat portion 13-2.

Specifically, the detection device 400 may calculate the difference in coordinate value of the third coordinate axis between portions adjacent to each other among portions having the same coordinate value of the first coordinate axis of the flat portion 13-2, and determine that the flat portion 13-2 is defective when the difference in coordinate value of the third coordinate axis between the portions adjacent to each other among the portions having the same coordinate value of the first coordinate axis of the flat portion 13-2 is greater than or equal to a preset third value.

The difference in coordinate value of the third coordinate axis between the portions adjacent to each other among the portions having the same coordinate value of the first coordinate axis of the flat portion 13-2 is the difference in height of the flat portion 13-2 in a direction parallel to the first direction.

For example, in the flat portion 13-2, the difference in height between coordinates having a coordinate value of (1, 2, 4) and coordinates having a coordinate value of (1, 3, 6) is 2.

The difference in height of the flat portion 13-2 may be less than the preset third value when there is no wrinkling or cracking of the flat portion 13-2.

However, when the flat portion 13-2 is wrinkled or cracked, a concavely recessed portion or a convexly protruding portion is formed on the flat portion 13-2, so that the difference in height of the flat portion 13-2 in the direction parallel to the first direction may be greater than or equal to the preset third value.

Therefore, when the difference in height of the flat portion 13-2 in the direction parallel to the first direction is greater than or equal to the preset third value, the detection device 400 determines that the flat portion 13-2 is defective, thereby detecting the defect in the non-coated portion 11.

In addition, the detection device 400 may detect a defect in the welded portion 13-1.

Specifically, the detection device 400 may calculate the difference in coordinate value of the third coordinate axis between portions adjacent to each other among portions having the same coordinate value of the first coordinate axis of the welded portion 13-1, and determine that the welded portion 13-1 is defective when the difference in coordinate value of the third coordinate axis between the portions adjacent to each other among the portions having the same coordinate value of the first coordinate axis of the welded portion 13-1 is greater than or equal to a preset fourth value.

The difference in coordinate value of the third coordinate axis between the portions adjacent to each other among the portions having the same coordinate value of the first coordinate axis of the welded portion 13-1 is the difference in height of the welded portion 13-1 in the direction parallel to the first direction.

For example, in the welded portion 13-1, the difference in height between coordinates having a coordinate value of (2, 4, 5) and coordinates having a coordinate value of (2, 5, 8) is 3.

The difference in height of the welded portion 13-1 may be less than the preset fourth value when there is no wrinkling or cracking of the welded portion 13-1.

Because the welded portion 13-1 is generally configured not to be flatter compared with the flat portion 13-2, the difference in height in the direction parallel to the first direction of the welded portion 13-1 in which wrinkling or cracking occurs may be greater than the difference in height in the direction parallel to the first direction of the flat portion 13-2 in which wrinkling or cracking does not occur.

That is, the preset fourth value may be greater than the preset third value.

However, when the welded portion 13-1 is wrinkled or cracked, a concavely recessed portion or a convexly protruding portion is formed on the welded portion 13-1, so that the difference in height of the welded portion 13-1 in the direction parallel to the first direction may be greater than or equal to the preset fourth value.

Therefore, when the difference in height of the welded portion 13-1 in the direction parallel to the first direction is greater than or equal to the preset fourth value, the detection device 400 determines that the welded portion 13-1 is defective, thereby detecting the defect in the non-coated portion 11.

Meanwhile, a welded mass may be formed in at least a part of the welded portion 13-1, and the detection device 400 may detect a defect in the welded portion 13-1 in which the welded mass is formed.

The expression “welded mass” may also be expressed, for example, as a welded nugget. For example, the “welded mass” or “welded nugget” may mean a portion which corresponds to a welding material that is melted during a welding process between the electrode tab 20 and the non-coated portion 11 and then solidified.

Specifically, the detection device 400 may calculate the difference in coordinate value of the third coordinate axis between a portion in which the welded mass is formed and a portion adjacent thereto among the portions having the same coordinate value of the first coordinate axis of the welded portion 13-1, and determine that the welded portion 13-1 is defective when the difference in coordinate value of the third coordinate axis is greater than or equal to a preset fifth value between the portion in which the welded mass is formed and the portion adjacent thereto among the portions having the same coordinate value of the first coordinate axis.

The difference in coordinate value of the third coordinate axis between the portion in which the welded mass is formed and the portion adjacent thereto among the portions having the same coordinate value of the first coordinate axis of the welded portion 13-1 is the difference in height in the direction parallel to the first direction between the welded mass and the portion adjacent to the welded mass.

For example, in the welded portion 13-1, the difference in height between coordinates of the welded mass having a coordinate value of (3, 4, 8) and coordinates of the portion adjacent to the welded mass having a coordinate value of (3, 5, 4) is 4.

The difference in height between the welded mass and the portion adjacent to the welded mass may be less than the preset fifth value when there is no wrinkling or cracking in the welded mass or the portion adjacent to the welded mass.

Because the welded portion 13-1 in which the welded mass is formed may be curved more compared with the welded portion 13-1 in which no welded mass is formed, the difference in height between the welded mass and the portion adjacent to the welded mass in which wrinkling or cracking occurs may be greater than the difference in height between the welded mass and the portion adjacent to the welded mass in which no wrinkling or cracking occurs.

That is, the preset fifth value may be greater than the preset fourth value.

However, when the welded mass or the portion adjacent to the welded mass is wrinkled or cracked, a concavely recessed portion or a convexly protruding portion is formed in the welded mass or the portion adjacent to the welded mass, so that the difference in height in the direction parallel to the first direction between the welded mass and the portion adjacent thereto may be greater than or equal to the preset fifth value.

Therefore, the detection device 400 may detect the defect in the non-coated portion 11 by determining that the welded portion 13-1 is defective when the difference in height in the direction parallel to the first direction between the welded mass and the portion adjacent to the welded mass is greater than or equal to the preset fifth value.

Hereinafter, a defect detection method of the non-coated portion 11 of the electrode assembly 10 according to an embodiment of the present disclosure will be described.

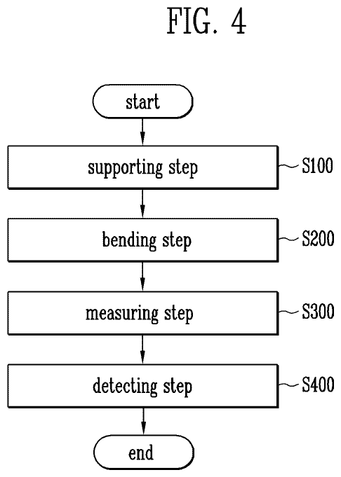

FIG. 4 is a flowchart illustrating a defect detection method of the non-coated portion 11 of the electrode assembly 10 according to an embodiment of the present disclosure.

Referring to FIG. 4, the defect detection method of the non-coated portion 11 of the electrode assembly 10 includes a supporting step S100, a bending step S200, a measuring step S300, and a detecting step S400.

First, the supporting step S100 will be described.

The supporting step S100 is a step of supporting the electrode assembly 10.

Specifically, the supporting step S100 may be a step of supporting the electrode assembly 10 with the support device 100 capable of supporting the electrode assembly 10.

The configuration of the support device 100 and the configuration of the electrode assembly 10 are the same as the configuration of the support device 100 and the configuration of the electrode assembly 10 of the defect detection system of the non-coated portion of the electrode assembly as described above, and thus a detailed description thereof will be omitted.

Next, the bending step S200 will be described.

The bending step S200 is a step of gripping and bending one side of the non-coated portion 11 of the electrode assembly 10.

Specifically, the bending step S200 may be a step of bending the non-coated portion 11 by gripping one side of the non-coated portion 11 with the gripping device 200 capable of gripping the non-coated portion 11.

By bending the non-coated portion 11 at the bending step S200, the inclined surface 12, and the flat surface 13 including the welded portion 13-1 and the flat portion 13-2 may be formed in the non-coated portion 11.

The configuration of the gripping device 200 and the configuration of the bent non-coated portion 11 are the same as the configuration of the gripping device 200 and the configuration of the bent non-coated portion 11 of the defect detection system of the non-coated portion of the electrode assembly as described above, and thus a detailed description thereof will be omitted.

Next, the measuring step S300 will be described.

The measuring step S300 may be a step of measuring the surface shape of the non-coated portion 11.

Specifically, the measuring step S300 may be a step of scanning the surface shape of the non-coated portion 11 with the measuring device 300 to measure the surface shape of the non-coated portion 11 in the range of the predetermined measurement area A.

The configuration of the measuring device 300 and the configuration of a portion measured by the measuring device 300 in the non-coated portion 11 are the same as the configuration of the measuring device 300 and the configuration of a portion measured by the measuring device 300 in the non-coated portion 11 of the defect detection system of the non-coated portion of the electrode assembly as described above, and thus a detailed description thereof will be omitted.

In addition, the measuring device 300 may be arranged at a position corresponding to each of the cathode and the anode so that the cathode and anode portions of the non-coated portion 11 of the electrode assembly 10 may be simultaneously measured.

Next, the detecting step S400 will be described.

The detecting step S400 is a step of representing information on the surface shape of the non-coated portion 11 by coordinates in a coordinate system, and detecting a defect in the non-coated portion 11 based on the coordinates.

Specifically, the detecting step S400 may be a step of detecting a defect in the non-coated portion 11 by the detection device 400. The configuration of the detection device 400 and the configuration of the coordinate system are the same as the configuration of the detection device 400 and the configuration of the coordinate system of the defect detection system of the non-coated portion of the electrode assembly as described above, and thus a detailed description thereof will be omitted.

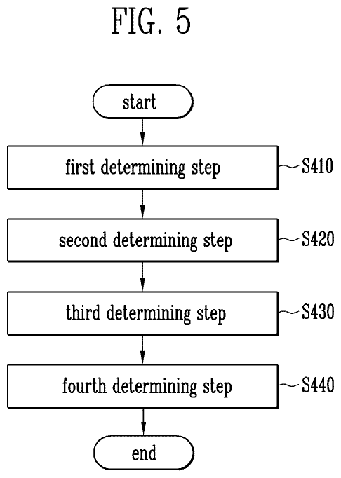

FIG. 5 is a flowchart illustrating the detecting step S400.

The detecting step S400 may include a first determining step S410, a second determining step S420, a third determining step S430, and a fourth determining step S440, as shown in FIG. 5.

At the first determining step S410, the slope of the inclined surface 12 in the second direction is calculated using the coordinates for the surface shape of the non-coated portion 11 represented in the coordinate system, and when the slope is less than or equal to the preset first value or is greater than or equal to the preset second value, the inclined surface 12 may be determined to be defective.

The configuration of the first determining step S410 is the same as the configuration in which the detection device 400 of the defect detection system of the non-coated portion of the electrode assembly determines the defect in the inclined surface 12 as described above, and thus a detailed description thereof will be omitted.

At the second determining step S420, the difference in coordinate value of the third coordinate axis may be calculated between portions adjacent to each other among portions having the same coordinate value of the first coordinate axis of the flat portion 13-2, and the flat portion 13-2 may be determined to be defective when the difference in coordinate value of the third coordinate axis between the portions adjacent to each other among the portions having the same coordinate value of the first coordinate axis of the flat portion 13-2 is greater than or equal to the preset third value.

The configuration of the second determining step S420 is the same as the configuration in which the detection device 400 of the defect detection system of the non-coated portion of the electrode assembly determines the defect in the flat portion 13-2 as described above, and thus a detailed description thereof will be omitted.

At the third determining step S430, the difference in coordinate value of the third coordinate axis may be calculated between portions adjacent to each other among portions having the same coordinate value of the first coordinate axis of the welded portion 13-1, and the welded portion 13-1 may be determined to be defective when the difference in coordinate value of the third coordinate axis between the portions adjacent to each other among the portions having the same coordinate value of the first coordinate axis of the welded portion 13-1 is greater than or equal to the preset fourth value.

The configuration of the third determining step S430 is the same as the configuration in which the detection device 400 of the defect detection system of the non-coated portion of the electrode assembly determines the defect in the welded portion 13-1 as described above, and thus a detailed description thereof will be omitted.

At the fourth determining step S440, when a welded mass is formed in at least a part of the welded portion 13-1, the difference in coordinate value of the third coordinate axis may be calculated between a portion in which the welded mass is formed and a portion adjacent thereto among portions having the same coordinate value of the first coordinate axis of the welded portion 13-1, and the welded portion 13-1 may be determined to be defective when the difference in coordinate value of the third coordinate axis between the portion in which the welded mass is formed and the portion adjacent thereto among the portions having the same coordinate value of the first coordinate axis is greater than or equal to the preset fifth value.

The configuration of the fourth determining step S440 is the same as the configuration in which the detection device 400 of the defect detection system of the non-coated portion of the electrode assembly determines the defect in the welded portion 13-1 in which the welded mass is formed as described above, and thus a detailed description thereof will be omitted.

The order of the first determining step S410, the second determining step S420, the third determining step S430, and the fourth determining step S440 which constitute the detecting step S400 may be different.

As described above, the defect detection system and the defect detection method of the non-coated portion of the electrode assembly according to the present disclosure may accurately detect the defect in the non-coated portion because the detection device coordinates the shape of the non-coated portion and detects the defect in the non-coated portion based on the coordinates.

In addition, because the defect in the non-coated portion is detected with different defect detection conditions for respective portions of the non-coated portion, the defect in the non-coated portion may be detected more accurately.

In addition, because the defect in the non-coated portion is automatically detected using the detection device, the defect in the non-coated portion may be detected more quickly.

In addition, a defect detection system of a non-coated portion of an electrode assembly according to in another embodiment of the present disclosure, the defect detection system may comprise a support device configured to support the electrode assembly, a gripping device configured to grip and bent one side of the non-coated portion of the electrode assembly to have an inclined surface by movement of the gripping device in a first direction, and a flat surface which is bent from the inclined surface by being gripped by the gripping device and extends in a second direction perpendicular to the first direction, a measuring device configured to measure a surface shape of the non-coated portion, and a detection device configured to map a surface shape of the non-coated portion by assigning coordinates within a coordinate system, and to identify defects in the non-coated portion based on these mapped coordinates.

In addition, a defect detection method of non-coated portion of an electrode assembly according to in another embodiment of the present disclosure, the defect detection method may comprise supporting the electrode assembly, gripping and bending one side of the non-coated portion of the electrode assembly, measuring a surface shape of the non-coated portion to obtain measurement information, and representing the measurement information using coordinates within a coordinate system, and detecting a defect in the non-coated portion based on the coordinates.

In addition, a defect detection method of non-coated portion of an electrode assembly according to in another embodiment of the present disclosure, detecting the defect may include calculating a slope of the inclined surface in the second direction using the coordinates and determining that the inclined surface is defective when the slope is less than or equal to a preset first value or greater than or equal to a preset second value.

The foregoing description of the present disclosure is for illustrative purposes, and those skilled in the art may understand that the present disclosure may be easily modified into other specific forms without changing the technical spirit or essential features of the present disclosure. It is, therefore, to be understood that the embodiments described above are illustrative in all respects and not restrictive. For example, each component described as being unitary may be implemented as separate components, and likewise, components described as being separate components may be implemented in a combined form.

The scope of the present disclosure is defined by the appended claims rather than the foregoing detailed descriptions, and all changes or modifications derived from the meaning and scope of the claims and their equivalents are to be construed as included in the scope of the present disclosure.

What is claimed is:

1. A defect detection system of a non-coated portion of an electrode assembly, the defect detection system comprising:
a support device configured to support the electrode assembly;
a gripping device configured to grip and bend one side of the non-coated portion of the electrode assembly;
a measuring device configured to measure a surface shape of the non-coated portion to obtain measurement information; and
a detection device configured to represent the measurement information using coordinates within a coordinate system and detect a defect in the non-coated portion based on the coordinates.

2. The defect detection system of claim 1,
wherein the non-coated portion includes an inclined surface which is formed by bending the non-coated portion by moving of the gripping device in a first direction, and a flat surface which is bent from the inclined surface by being gripped by the gripping device and extends in a second direction perpendicular to the first direction, and
wherein the coordinate system includes a first coordinate axis parallel to the second direction, a second coordinate axis parallel to a third direction perpendicular to the first direction and the second direction, and a third coordinate axis parallel to the first direction.

3. The defect detection system of claim 2, wherein the detection device:
calculates a slope of the inclined surface in the second direction using the coordinates; and
determines that the inclined surface is defective when the slope is less than or equal to a preset first value or greater than or equal to a preset second value.

4. The defect detection system of claim 3, wherein the flat surface includes a welded portion welded to an electrode tab and a flat portion which is a portion of the flat surface except for the welded portion, and
wherein the detection device:
calculates a difference in coordinate value of the third coordinate axis between portions adjacent to each other in the direction of the first coordinate axis among portions having a same coordinate value of the first coordinate axis of the flat portion; and
determines that the flat portion is defective when the difference in coordinate value of the third coordinate axis between the portions adjacent to each other in the direction of the first coordinate axis among the portions having the same coordinate value of the first coordinate axis of the flat portion is greater than or equal to a preset third value.

5. The defect detection system of claim 4, wherein the detection device:
calculates a difference in coordinate value of the third coordinate axis between portions adjacent to each other in the direction of the first coordinate axis among portions having a same coordinate value of the first coordinate axis of the welded portion; and
determines that the welded portion is defective when the difference in coordinate value of the third coordinate axis between the portions adjacent to each other in the direction of the first coordinate axis among the portions having the same coordinate value of the first coordinate axis of the welded portion is greater than or equal to a preset fourth value.

6. The defect detection system of claim 5, wherein a welded mass is formed in at least a part of the welded portion, and
wherein the detection device:
calculates a difference in coordinate value of the third coordinate axis between a portion in which the welded mass is formed and a portion adjacent thereto in the direction of the first coordinate axis among the portions having the same coordinate value of the first coordinate axis of the welded portion; and
determines that the welded portion is defective when the difference in coordinate value of the third coordinate axis between the portion in which the welded mass is formed and the portion adjacent thereto in the direction of the first coordinate axis among the portions having the same coordinate value of the first coordinate axis of the welded portion is greater than or equal to a preset fifth value.

7. The defect detection system of claim 6, wherein the preset fourth value is greater than the preset third value, and
wherein the preset fifth value is greater than the preset fourth value.

8. The defect detection system of claim 3, wherein the gripping device comprises:
a lower cylinder configured to press an end portion of the bottom surface of the non-coated portion in the first direction; and
an upper cylinder configured to press the end portion of the top surface of the non-coated portion in a direction opposite to the first direction.

9. The defect detection system of claim 8, wherein the measuring device includes a profile sensor.

10. A defect detection method of non-coated portion of an electrode assembly, the defect detection method comprising:
a supporting step of supporting the electrode assembly;
a bending step of gripping and bending one side of the non-coated portion of the electrode assembly;
a measuring step of measuring a surface shape of the non-coated portion to obtain measurement information; and
a detecting step of representing the measurement information using coordinates within a coordinate system; and
detecting a defect in the non-coated portion based on the coordinates.

11. The defect detection method of claim 10, wherein the non-coated portion includes an inclined surface which is formed by bending the non-coated portion by moving of a gripping device in a first direction, and a flat surface which is bent from the inclined surface by being gripped by the gripping device and extends in a second direction perpendicular to the first direction, and
wherein the coordinate system includes a first coordinate axis parallel to the second direction, a second coordinate axis parallel to a third direction perpendicular to the first direction and the second direction, and a third coordinate axis parallel to the first direction.

12. The defect detection method of claim 11, wherein the detecting step includes a first determining step of calculating a slope of the inclined surface in the second direction using the coordinates, and determining that the inclined surface is defective when the slope is less than or equal to a preset first value or greater than or equal to a preset second value.

13. The defect detection method of claim 12, wherein the flat surface includes a welded portion welded to an electrode tab and a flat portion which is a portion of the flat surface except for the welded portion, and
wherein the detecting step further includes a second determining step of calculating a difference in coordinate values of the third coordinate axis between portions adjacent to each other in the direction of the first coordinate axis among portions having a same coordinate value of the first coordinate axis of the flat portion, and determining that the flat portion is defective when the difference in the coordinate values of the third coordinate axis between the portions adjacent to each other in the direction of the first coordinate axis among the portions having the same coordinate value of the first coordinate axis of the flat portion is greater than or equal to a preset third value.

14. The defect detection method of claim 13, wherein the detecting step further includes a third determining step of calculating a difference in coordinate values of the third coordinate axis between portions adjacent to each other in the direction of the first coordinate axis among portions having a same coordinate value of the first coordinate axis of the welded portion, and determining that the welded portion is defective when the difference in the coordinate values of the third coordinate axis between the portions adjacent to each other in the direction of the first coordinate axis among the portions having the same coordinate value of the first coordinate axis of the welded portion is greater than or equal to a preset fourth value.

15. The defect detection method of claim 14, wherein a welded mass is formed in at least a part of the welded portion, and
wherein the detecting step includes a fourth determining step of calculating a difference in coordinate values of the third coordinate axis between a portion in which the welded mass is formed and a portion adjacent thereto in the direction of the first coordinate axis among the portions having the same coordinate value of the first coordinate axis of the welded portion, and determining that the welded portion is defective when the difference in the coordinate values of the third coordinate axis between the portion in which the welded mass is formed and the portion adjacent thereto in the direction of the first coordinate axis among the portions having the same coordinate value of the first coordinate axis of the welded portion is greater than or equal to a preset fifth value.
